(19) United States
(12) Patent Application Publication
(10) Pub. No.: US 2014/0105866 A1
(43) Pub. Date: Apr. 17, 2014

(54) BACTERIOPHAGES USEFUL FOR THE PROPHYLAXIS AND THERAPY OF VIBRIO ANGUILLARUM

(71) Applicant: Universidad de Chile, Santiago (CL)

(72) Inventors: Romilio Hernan ESPEJO TORRES, Santiago (CL); Jaime Moises ROMERO ORMAZABAL, Santiago (CL); Roberto Andres BASTIAS ROMO, Santiago (CL); Gaston Ariel HIGUERA GUAJARDO, Santiago (CL)

(73) Assignee: Universidad de Chile, Santiago (CL)

(21) Appl. No.: 14/055,279

(22) Filed: Oct. 16, 2013

(30) Foreign Application Priority Data
Oct. 17, 2012 (CL) 2902-2012

(51) Int. Cl. A01N 63/02

(52) U.S. Cl. CPC A01N 63/02
USPC 424/93.6; 435/235.1

(57) ABSTRACT

An isolated strain of bacteriophage, specific against bacteria belonging to the Vibrio genre, particularly the anguillarum species, deposited on 3 Oct. 2012 at the Polish Collection of Microorganisms (PCM) of the Ludwik Hirszfeld Institute of Immunology and Experimental Therapy of the Polish Academy of Sciences, with access number F/00072, characterized in that said strain is efficient in the prophylaxis, control and/or treatment of the infection caused by Vibrio anguillarum in all types of species of fish, mollusks and crustaceans that are important for aquaculture susceptible to this bacteria, genome size 48.6 Kb, it is not sensitive to chloroform and its storage temperature is −80° C.

### FIELD OF THE INVENTION

This invention is applicable in the aquaculture industry. It consists of the use of new native bacteriophages, and the different mixtures of them, for use in controlling the infection produced by the pathogenic bacteria Vibrio anguillarum. This bacteria causes vibriosis in fish, mollusks and crustaceans, many of which are economically important for this industry.

### BACKGROUND INFORMATION OF THE INVENTION

Problem. Inefficiency of Current Treatments

At present, antibiotics continue being the main therapeutic tool for the treatment of bacterial diseases in the production of fish, mollusks and crustaceans. The effectiveness of the treatment with antibiotics has dropped drastically due to the explosive increase of bacteria that are resistant to these drugs; this is explained by the bacteria's great adaptability which allows them to develop resistance to antibiotics (Cabello 2006). This has produced a series of collateral effects, such as: increase of the dose to control the disease, which contributes to producing greater resistance in the pathogenic or environmental bacteria; persistence in the final product and therefore longer periods of unavailability; among others (Cabello 2006; Marshall and Levy 2011; Millanao, Barrientos et al. 2011). This situation is exacerbated considering recent evidence that suggest the horizontal transference of antibiotic resistant genes from aquatic bacteria to bacteria that are potentially pathogenic for the human being (Marshall and Levy 2011; Millanao, Barrientos et al. 2011).

On the other hand, existing vaccinations to prevent bacterial diseases, including vibriosis, in species that are important for aquaculture are not completely effective. This is reflected in the prevalence of a variety of bacterial pathogens in the aquaculture industry, over time.

That is why, given the critical reality of the exposure to pathogens and the inefficacy of the current treatments employed by the aquaculture industry, the need arises to produce new alternatives for the control or treatment of bacterial infections. One of the most promising and attractive options is the use of bacteriophages (phages) as antibacterials (Kutateladze and Adamia 2010).

### Basis of Phagotherapy for the Control of Bacterial Diseases

The bacteriophages or phages are virus that infect only bacteria and therefore, are inoffensive for the host cells (eukaryotic cells). It is estimated that the bacteriophages are the most abundant biological entity on the planet, with an approximate proportion of 10 bacteriophages for each bacteria (Wommack and Colwell 2000). Basically there are two types of bacteriophages: those that are obligatorily lytic and the temperate. After infecting the host bacteria, the lytic bacteriophages use it to permit the release of the new progeny, which consists of hundreds of viral particles that will infect more host bacteria, repeating the lytic cycle. This translates into a reduction in the number of target bacteria, thus permitting the use of these viruses in biotechnological applications for prophylactic and therapeutic treatments of fish.

Advantages of the Application of Phages in Relation to the Treatment with Antibiotics

The current prevalence of many bacteria resistant to antibiotics gives the lytic phages a renewed importance as they are capable of destroying their host bacterium (target), by means of lysis, which represents a great therapeutic and prophylactic potential. The principal advantages of the phages in the control of infectious bacterial diseases are:
1) They have a high specificity; infecting only one bacterial species or even one bacterial strain, therefore they avoid undesired effects such as altering the normal microbiota of the fish, the environment or the human being.
2) They are self-replicable; that is, they multiply as they find the presence of their target bacterium, which could reduce the number of applications.
3) Their innocuousness and safety: it has been widely reported that bacteriophages do not present any risk for animal and human health, added to the fact that they do not generate any type of immune reaction; they could even be used in immune-suppressed hosts (Borysowsky Gorski 2008), unlike what occurs with some antibiotics. The bacteriophages are omnipresent and are consumed continuously and involuntarily through the food and water. Because of this, it is believed that phages are innocuous for the host as no undesired effect as been reported as a result of their consumption (Housby and Mann 2009);
4) Selection of new phages is quick and easy; it is a relatively rapid process that can take only a few days or weeks to obtain phages capable of infecting a new bacterial strain, unlike the development of a new antibiotic that can take years.

### Advantages in Aquaculture

In the field of aquaculture we can point out the following advantages:
1) Unrestricted use, without limitations because it has no impact on the environment;
2) Zero period of unavailability, that is, the fish may be harvested irrespective of when the products based on phages were applied;
3) Lower development cost, in comparison with antibiotics and vaccines;
4) Organic production, it permits fish cultivation under an organic production system.

In a nutshell, the use of bacteriophages for the control of bacterial infections is a really attractive alternative because they are lethal to bacteria.

Pathogenic Bacteria: Vibrio anguillarum

Vibrio anguillarum is a gram-negative bacterium capable of producing vibriosis in more than 50 species of fish; this pathogen is even capable of infecting some types of mollusks and crustaceans (Frans. Michiels et al. 2011). Nowadays, 23 serotypes (01-023) have been found; nevertheless 108 serotypes 01, 02 and 03 have been associated with vibriosis (Silva-Rubio, Acevedo et al. 2008; Silva-Rubio. Avendailo-Herrera et al. 2008; Frans. Michiels et al. 2011). On the other hand, V. anguillarum is one of the main pathogenic bacterium emerging from salmonids in the fattening stage in the national industry and it has been described that the Chilean strains belong to serotype 03 (Sernapesca Report. 2009).

The aquaculture industry treats this disease mainly with antibiotics, and in some cases it is prevented with some vaccines present in the market, essentially for serotypes 01 and 02. Nevertheless, none of the alternatives for control existing at present permits the individual or joint control of the problem of vibriosis.

Several studies have been made that describe the isolation of bacteriophages originating from different places and types of samples that are capable of infecting and destroying different species of pathogen bacteria in the aquaculture industry (Wommack and Colwell 2000; Stenholm, Dalsgaard et al., 2008; Almeida, Cunha et al., 2009; Kim, Gomez et al., 2010). Nevertheless, none have been found with regard to a methodology focused on using phages against V. anguillarum to control the infection of this pathogenic bacterium in species that are important for aquaculture.

This invention presents new native bacteriophages, and their different mixes, that are capable of infecting a V. anguillarum and control the infection of this pathogenic bacterium in fish, especially in salmonids. This strategy is easily applicable to other types of marine farming such as crustaceans and mollusks. To do this, the phages were isolated from places related to aquaculture or marine environments, and characterized to be tested and demonstrate their usefulness as prophylaxis, control and/or treatment of the infection caused by this pathogenic bacterium, in crops of fish, mollusks and crustaceans susceptible to vibriosis.

### State of the Art

The document, WO2009138752A2, divulges the use of phage particles for the manufacture of a medication to develop an immune response in cultivated varieties of fish, mollusks and other aquatic animals against different infections, among them the one caused by Vibrio anguillarum. The phages of this document include an exogenous nucleic acid under the control of a eukaryotic promoter. This document does not interfere with the present invention as it does not divulge the use of native phages for the control of the infection by Vibrio anguillarum, but rather the use of phages as vectors.

The document WO2007128348A 1, divulges a composition for treating a bacterial infection, specifically vibriosis, in cultivated varieties of aquatic organisms, that includes at least one lytic enzyme of a bacteriophage that is capable of using the bacteria that produces the infection and also the inactive bacteriophage. The document mentions phages of Vibrios in general and of Vibrio harveyi and Vibrio Campbell in particular. This document does not interfere with the present invention as it does not use active native bacteriophages to control the infection caused by Vibrio anguillarum.

The documents of Castillo et al., of 2012 (Castillo, D; Higuera, G; Villa, M; Middelboe, M; Dalsgaard, I; Madsen, L; Espejo, R T; 2012. Diversity of Flavobacterium psychrophilum and the potential use of its phages for protection against bacterial cold water disease in salmonids, JOURNAL OF FISH DISEASES; 35 (3): 193-201 MAR 2012); of Pereira et al., of 2011 (Pereira, C; Silva, YJ; Santos, Al; Cunha, A.; Gomes, NCM; Almeida, A., 2011. Bacteriophages with potential for inactivation of fish pathogenic bacteria: survival, host specificity and effect on bacterial community structure, MARINE DRUGS; 9 (11): 2236-2255 NOV 2011); of Thiyagarajan et al., of 2011 (Thiyagarajan, S; Chrisolite, B; Alavandi, SV; Poomima, M; Kalaimani, N; Santiago, TC; 2011. Characterization of four lytic transducing bacteriophages of luminescent Vibrio harveyi isolated from shrimp (Penaeus monodon) hatchery. FEMS MICROBIOLOGY LETTERS; 325 (1): 85-91 DEC 2011); of Prasad et al., of 2010 (Prasad, Y; Apama; Kumar, O, 2010. Isolation and efficacy evaluation of virulent bacteriophages specific to fish pathogenic bacterium, Flavobacterium columnare, JOURNAL OF APPLIED ANIMAL RESEARCH; 38 (2): 169-174 DEC 2010); of Phumkhachom et al., of 2010 (Phumkhachom, P; Rattanachaikunsopon, P; 2010. Isolation and partial characterization of a bacteriophage infecting the shrimp pathogen Vibrio harveyi, AFRICAN JOURNAL OF MICROBIOLOGY RESEARCH; 4 (16): 1794-1800 AUG 18 2010); of Crothers-Stomps et al., of 2010 (Crothers-Stomps, C; Hoj, L; Bourne, DG; Hall, MR; Owens, L., 2010. Isolation of lytic bacteriophage against Vibrio harveyi, JOURNAL OF APPLIED MICROBIOLOGY; 108 (5): 1744-1750 MAY 2010); of Karunasagar et al., of 2007 (Karunasagar, I; Shivu, MM; Girisha, SK; Krohne, G; 2007. Biocontrol of pathogens in shrimp hatcheries using bacteriophages, AQUACULTURE; 268 (1-4): 288-292 Sp. Iss. Si. AUG 22 2007); of Shivu et al., of 2007 (Shivu, MM; Rajeeva, BC; Girisha, SK; Karunasagar, I; Krohne, G, 2007. Molecular characterization of Vibrio harveyi bacteriophages isolated from aquaculture environments along the coast of India, ENVIRONMENTAL MICROBIOLOGY; 9 (2): 322-331 FEB 2007); and of Vinod et al., of 2006 (Vinod, MG; Shivu, MM; Umesha, KR; Rajeeva, BC; Krohne, G; Ka-Unasagar, I; Karunasagar, I; 2006. Isolation of Vibrio harveyi bacteriophage with a potential for biocontrol of luminous vibriosis in hatchery environments, AQUACULTURE; 255 (1-4): 117-124 MAY 31 2006), describe the isolation, characterization and use of phages to control bacterial infections in aquaculture farming. These documents do not interfere with the present invention because none of them mention the use of phages to control the infection caused by Vibrio anguillarum.

### BRIEF DESCRIPTION OF THE INVENTION

This invention provides four strains of phages isolated from places related to aquaculture or marine environments that are specific against bacteria belonging to the Vibrio genre, in particular the anguillarum species, which is efficient in the prophylaxis, control and/or treatment of the infection caused by Vibrio anguillarum in all types of fish, mollusk and crustacean species that are important to the aquaculture industry susceptible to this bacterium. This invention also describes antibacterial compositions based on the strains of previous bacteriophages, and optionally excipients and formulations of the antibacterial compositions to be used in the prophylaxis, control and/or treatment of the infection caused by Vibrio anguillarum in all types of fish, mollusk and crustacean species of importance to the aquaculture industry susceptible to this bacterium. The compositions and formulations of this invention are added directly to the water in which the species to be treated are being cultivated, or rather, they are used to associate them to controlled liberation matrixes or to include them in the food.

### DETAILED DESCRIPTION OF THE INVENTION

This invention presents the isolation, characterization and testing of new native bacteriophages, and their different mixes, originating from places related to aquaculture or marine environments that are capable of infecting and destroying V. anguillarum, so as to control the infection of this pathogen in species that are important to aquaculture, especially salmonids.

This invention provides four strains of new native isolated bacteriophages, specifically against bacteria belonging to the Vibrio genre, particularly the anguillarum species that is effective for the prophylaxis, control and/or treatment of the infection caused by Vibrio anguillarum in all types of species (fish, mollusks, crustaceans) that are important for aquacultures susceptible to this bacterium. The strains were isolated from different marine sources and characterized for storage under different conditions of cold, sensibility to chloroform, morphological structure, according to groups of the restriction fragment length polymorphism (RFLP), determining the range of hosts and frequency of phage-resistant bacteria.

The phage strains selected were deposited in the Polish Collection of Microorganisms (PCM) of the Ludwik Hirszfeld Institute of Immunology and Experimental Therapy of the Polish Academy of Sciences, Rudolfa Weigia 12, 53-114, Breslavia, Poland on 3 Oct. 2012 where they received the following access numbers: F/00072, F/00073, F/00074 and F/00075.

Table 1 presents the characteristics of the phage strains of this invention.

TABLE 1
Characteristics of the phage strains of this invention.

| | Phages | | | |
|---|---|---|---|---|
| Characteristic | F/00072 | F/00073 | F/00074 | FY00075 |
| Family | n/d | Siphoviridae | Siphviridae | n/d |
| RFLP Group | B | C | A | n/d |
| Origin | Mussels | Clams | Mussels | Clams |
| Nucleic acid | DNA | DNA | DNA | n/d |
| Genome size | 48.8 | 47 | 48.3 | n/d |
| (Kb) | | | | |
| Sensitivity to | no | no | no | Yes |
| chloroform | | | | |
| Storage | −80° C. | −80° C. | 4° C. | 4° C. |
| temperature | | | | |
| Vibrio strains | VoATCC, | — | VoATCC, | VaPF8 |
| tested highly | VaPF4, | | VaPF4, | |
| infecting | VaPF8 | | VaPF8 | |
| Vibrio strains | — | VoATCC, | — | VoATCC |
| tested medium | | VaPF4 | | VaPF4 |
| infecting | | | | |
| Vibrio strains | — | VaPF8 | — | — |
| tested low | | | | |
| infecting | | | | |
| Frequency of | n/d | n/d | 1 in 5.83 × | 1 in 1.63 × |
| bacteria of PF4 | | | 10⁻⁶ | 10⁻² |
| strain of | | | | |
| V. anguillarum | | | | |
| resistant | | | | |

n/d = not determined
(Vo = Vibrio ordalii; Vp = Vibrio parahaemolyticus; Va = Vibrio anguillarum).

The F/00072 strain is specific against bacterium belonging to the Vibrio genre, particularly the anguillarum species, was isolated from mussels, the size of its genome is 48.6 Kb, it is not sensitive to chloroform, its storage temperature is −80° C. and the Vibrio strains tested (VoATCC, VaPF4 and VaPF8) were highly infected by it.

The F/00073 strain is specific against bacteria belonging to the Vibrio genre, specifically the anguillarum species belonging to the Siphoviridae family, its head has the form of icosahedrons, it has a long tail, is not retractile, was isolated from clams, the size of its genome is 47 Kb, it is not sensitive to chloroform, its storage temperature is −80° C., infects to an average degree the tested Vibrio strains VoATCC and VaPF4 and to a low degree the strain VaPF8.

The F/00074 strain is specific against bacteria belonging to the Vibrio genre, specifically the anguillarum species, belongs to the Siphoviridae family, its head has the form of icosahedrons, it has a long tail, is not retractile, was isolated from mussels, the size of its genome is 48.3 Kb, it is not sensitive to chloroform, its storage temperature is 4° C., the Vibrio strains (VoATCC, VaPF4 and VaPF8) tested were highly infected by it, and the frequency of bacteria of the PF4 strain of V. anguillarum that are resistant to it is of 1 in 5.63×10⁻⁶.

The F/00075 strain is specific against bacteria belonging to the Vibrio genre, particularly the anguillarum species, its head has the form of icosahedrons, long tail, is not retractile, was isolated from clams, is sensitive to chloroform, its storage temperature is 4° C., the Vibrio VaPF8 strain tested was highly infected by it and the strains VoATCC and VaPF4 were infected to a medium degree.

This invention provides an antibacterial composition that includes at least one phage strain selected from among the strains deposited on 3 Oct. 2012 at the Polish Collection of Microorganisms of the Ludwik Hirszfeld Institute of Immunology and Experimental Therapy of the Academy of Sciences of Poland with the access number F/00072, F/00073, F/00074 and F/00075 or any combination of them, to be applied as prophylaxis, control and/or treatment of the infection caused by V. anguillarum in all types of crops of fish, mollusks and crustaceans susceptible to this pathogen bacterium.

In a preferred embodiment, the antibacterial composition additionally includes, optionally, a buffer solution and/or nutrients and/or phage stabilizers and/or thickeners and/or other excipients.

In a preferred embodiment, the antibacterial composition includes at least one phage strain selected from among the strains deposited on 3 Oct. 2012 at the Polish Collection of Microorganisms of the Ludwik Hirszfeld Institute of Immunology and Experimental Therapy of the Academy of Sciences of Poland with the access number F/00072, F/00073, F/00074 and F/00075 or any combination of them, in a multiplicity of infection (MOI) of between 1 and 200. In an even more preferred embodiment, the MOI is 200 in order to increase the options of a meeting between phage and bacterium.

In a preferred embodiment, the antibacterial composition is applied to crops of any species of fish, mollusks or crustaceans susceptible to being infected by V. anguillarum, for prophylaxis, control and/or treatment of this infection.

In a particular embodiment, the antibacterial composition is applied to crops of, for example but not limited to, the following species of fish sensitive to V. anguillarum: all types of salmonids, cod, sea bream, sea bass, turbot, eel and ayu, for prophylaxis, control and/or treatment of the infection caused by V. anguillarum.

In another particular embodiment, the antibacterial composition is applied to crops of, for example but not limited to, the following mollusks: oysters, clams, large mussels or any filtrating bivalve for prophylaxis, control and/or treatment of the infection caused by V. anguillarum.

In another particular embodiment, the antibacterial composition is applied to crops of, for example but not limited to, the crustacean named salt water shrimp, for prophylaxis, control and/or treatment of the infection caused by V. anguillarum.

The antibacterial composition of this invention is added directly to the water in which the species to be treated are cultivated or else it is used to associate it to controlled liberation matrixes or to include them in the food.

The formulation of the antibacterial composition is a concentrated form that includes at least one phage strain selected from among the strains deposited on 3 Oct. 2012 at the Polish Collection of Microorganisms of the Ludwik Hirszfeld Institute of Immunology and Experimental Therapy of the Academy of Sciences of Poland with the access number F/00072, F/00073, F/00074 and F/00075 or any combination of them, in different or similar proportions. In a particular embodiment the formulations of the antibacterial composition of this invention additionally include, optionally, excipients, particularly excipients that stabilize the biological structures.

In a preferred embodiment, the antibacterial composition is prepared in a formulation in a buffered medium at a pH between 4 and 10, liquid or semisolid and whose active ingredients are concentrated in order to permit broad applications such as its incorporation into the food, or liberating matrixes, among others. The formulation of the antibacterial composition includes, F/OOO72: between O ufp/ml and 1×10¹⁰ ufp/ml; F/00073: between O and 1×10¹⁰ ufp/ml; F/OOO74: between O ufp/ml and 1×10¹⁰ ufp/ml; F/00075: between O ufp/ml and 1×10¹⁰ ufp/ml.

In another preferred embodiment, the formulation of antibacterial composition additionally includes nutrients and/or bacteriophage stabilizers and/or thickeners and/or other excipients.

In preferred embodiments, the formulations of this invention include one or more of the following components: Tris as a buffer solution that has a pH ranging between 4 and 10; NaCl as a nutrient required for bacterium growth; MgSO₄ as a nutrient required for bacterium growth and as a factor for phage absorption; guar gum as a phage stabilizing medium and solution thickener; and/or bovine serum albumin as stabilizer of the protein structures of the phages.

In a preferred embodiment, the formulation of the antibacterial composition is applied to crops of any species of fish, mollusks or crustaceans susceptible to being infected by V. anguillarum, for prophylaxis, control and treatment of this infection.

In a preferred embodiment, the formulation of the antibacterial composition is applied to crops of, for example but not limited to, the following species of fish sensitive to V. anguillarum: all types of salmonids, cod, sea bream, sea bass, turbot, eel and ayu, for prophylaxis, control and/or treatment of the infection caused by V. anguillarum.

In another preferred embodiment, the formulation of the antibacterial composition is applied to crops of, for example but not limited to, the following mollusks: oysters, clams, large mussels or any filtrating bivalve for prophylaxis, control and/or treatment of the infection caused by V. anguillarum.

In another preferred embodiment, the formulation of the antibacterial composition is applied to crops of, for example but not limited to the crustacean named salt water shrimp, for prophylaxis, control and/or treatment of the infection caused by V. anguillarum.

The formulation of the antibacterial composition of this invention is added directly to the water in which the species to be treated is cultivated, or else it is used to associate it to the controlled liberation matrixes or to include them in the food.

Advantages of the use of native bacteriophages and different mixes of them, for the prophylaxis, control and/or treatment of the infection produced by Vibrio anguillarum.

Advantages of the Application of Phages in Relation to the Treatment with Antibiotics.

The main advantages of the bacteriophages with regard to antibiotics are:
1) High specificity, only kills the target pathogenic bacteria;
2) Innocuousness, have no negative effect for the environment, fish and humans;
3) They are self-replicable, they multiply when they infect the pathogen bacteria, which is why they remain in the medium while the target pathogens persist;
4) Rapid development of new treatments, the time for the isolation and characterization of the bactericide capacity of phages has a cycle smaller than traditional antibiotics;
5) They are natural products, compatible with organic production.

### Advantages in Aquaculture

In the field of aquaculture we can point out the following advantages:
1) Unrestricted use, without limitations as it has no impact on the environment;
2) No period of unavailability, that is, the fish can be harvested irrespective of when the products based on phages were applied;
3) Lower development cost, in comparison with antibiotics and vaccinations;
4) Organic production, it permits fish farming under an organic production system.
   Differences with Current Methods
1) Antibiotics are currently the main tool for treating outbreaks of vibriosis. The appearance of bacteria resistant to these drugs and the transference of this resistance among the bacteria have caused the antibiotics to increasingly lose their capacity to control. Multi-resistant bacterial strains were reported recently, that is, with the capacity to tolerate more than one antibiotic without altering their growth. On the contrary, the bacteria's capacity to develop resistance to phages is extremely low, for example, the appearance of a resistant over a population of 5.63×10⁶, (therefore approximately 5×10⁻⁶ of probability). Additionally, the probability that a bacterium may be produced that is resistant to two phages is the result of just how frequent resistance to them may be (for example: Phage A 1×10⁻⁶ and phage B 1×10⁻⁶, for both phages is 1×10⁻¹²), and the latter will decrease as the number of phages present increases.
2) The methods of preventive management in fish farming consists of the use of surface disinfectants (formalin, salt, hydrogen peroxide, etc.) administered by immersion; maintaining low densities of fish; cleaning of tanks; adequate feeding, among others. These managements have contributed to a partial reduction in the impact of vibriosis on salmon farming. The treatment or prevention of the infection by V. anguillarum using phages can be complementary to other previous preventive measures.
3) The strategy of vaccinating against vibriosis is still in the development stages. Most of the vaccines include the serotypes 01 and 02 of V. anguillarum in their formulas. Nevertheless, the Chilean strains belong to serotype 03 that are controlled by the phages of this invention.

None of the currently existing control alternatives, permits, either individually or jointly, the control of the problem of vibriosis in Chile, which is why this disease has been constantly prevalent in recent years, threatening the sustainability of the salmon industry.

### INDUSTRIAL APPLICATION

This invention is applicable to the aquaculture industry, particularly for the control of the infection produced by the pathogen bacterium Vibrio anguillarum that affects fish, mollusks and crustaceans that are economically important for this industry.

### BRIEF DESCRIPTION OF THE FIGURES

FIG. 1: Images of phages through transmission electron microscopy. A) phage F/00074, B) phage F/00073 and C) phage F/00075. All the phages show a binary symmetry with head and tail.

FIG. 2: Digestion of phage genomes with Hind III enzyme in polyacrylamide gel stained with silver. 150 volts for 45 minutes. 1) DNA Marker of 100 pb; 2) phage F/00074; 3) Phage F/00072; 4) phage F/00074; 5) Phage F/00073; 6) phage F/00073; 7) phage F/00073, 8) DNA marker of 100 pb.

FIG. 3: Challenge of protection against Vibrio anguillarum using the bacteriophage F/00075 under laboratory conditions. Survival rate of Atlantic salmon after being infected with the PF4 strain of V. anguillarum. (A) A multiplicity of infection of 7 was used (F/00075). (B) A multiplicity of infection of 150 of the phage F/00075 was used.

FIG. 4: Challenge of protection against Vibrio anguillarum using the bacteriophage F/00074 under laboratory conditions. Survival rate of Atlantic salmon after being infected with the PF4 strain of V. anguillarum. In (A) a multiplicity of infection of 1 of the phage F/00074 was used. (B) A multiplicity of infection of 20 of the phage F/00074 was used.

FIG. 5. Challenge of protection against Vibrio anguillarum using a mixture of the bacteriophages F/00074 and F/00075 under laboratory conditions. Survival rate of Atlantic salmon after being infected with the PF4 strain of V. anguillarum. Using a multiplicity of infection of 50 of the mixture (Cocktail).

FIG. 6. Challenge of protection against Vibrio anguillarum using the bacteriophage F/00074, under conditions similar to salmon farming centers. Survival rate of Atlantic salmon after being infected with the PF4 strain of V. anguillarum. Executed at the Chinquihue experimental center (Puerto Montt). A multiplicity of infection of 10 of the phage F/00074 was used.

### EXAMPLES

The following examples attempt to provide a detailed explanation of this invention; they are only illustrative and in no way limit the field of the invention.

### Example 1

### Isolation of Phages

The phages were isolated from mussels and clams from Santiago's central market. The soft tissue of the shellfish was homogenized and centrifuged, and then the supernatant was diluted ten times and filtered using filters with pores of 0.22 μm. One hundred μl of the filtrate was then used to detect the presence of phages following the standard protocol of double agar using a PF4 strain of Vibrio anguillarum as host.

Four phages were isolated originating from mussels and clams.

### Example 2

### Characterization of Phages

The storage mode was determined and the presence of membranes of the isolated phages. To determine the type of storage, aliquots of phage were incubated for a week at −80° C. and 4° C. and their titer was compared with the original stock. The presence of phage membrane was determined in the same way, by exposing the phages to chloroform. The sensitivity to chloroform indicates that the phages could present an external membrane. Therefore an aliquot of each phage was mixed with a drop of chloroform and then its titer was compared to the original stock. The phages were considered sensitive when their titer was reduced more than 3 orders of magnitude.

The values determined are shown in Table 2 below.

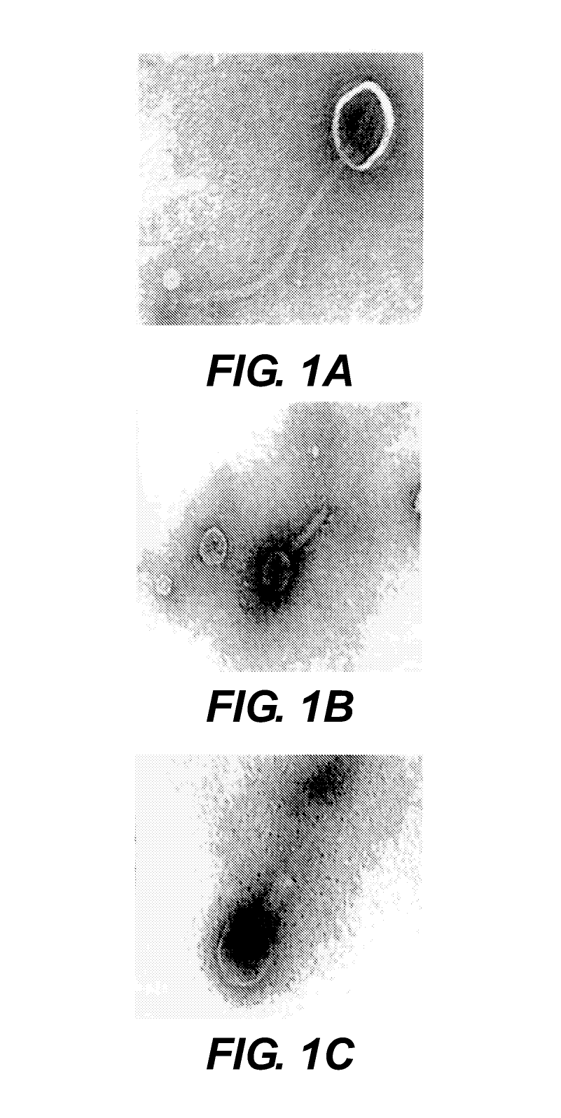

The morphological structure of some of the bacteriophages isolated through transmission electron microscopy (FIG. 1) was determined. All the phages show a binary symmetry with head and tail. The images show phages that belong to the Siphoviridae family.

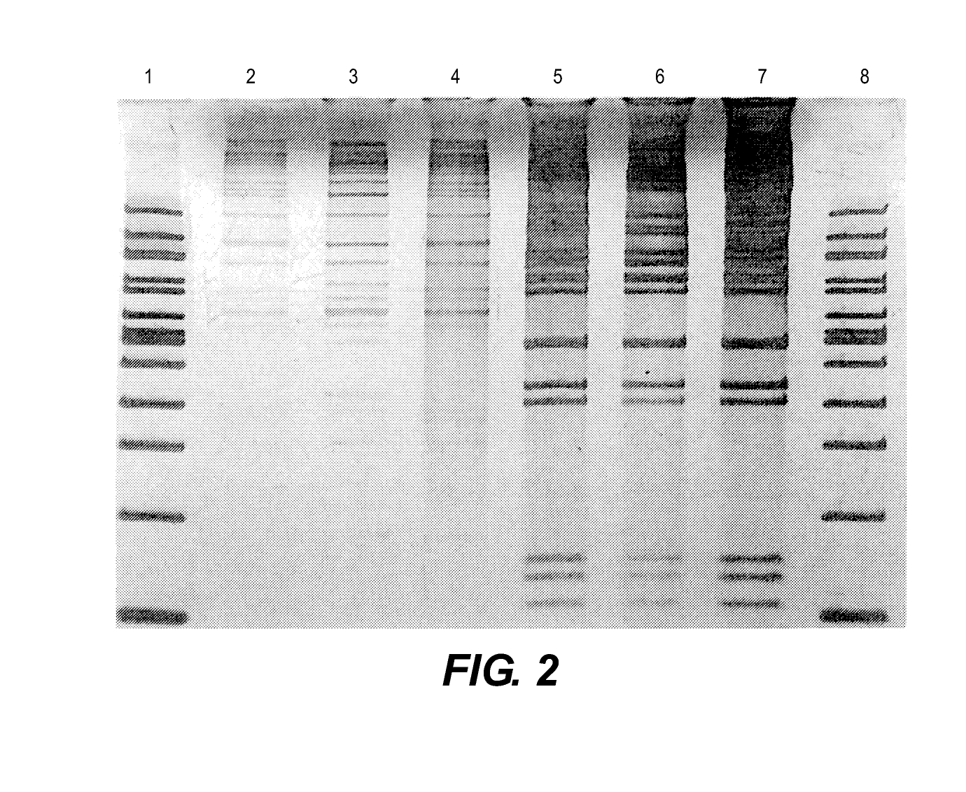

The type and size of the nucleic acids of some of the phages was determined. The genomic relationship between the phages was established through the different restriction patterns of the genomes isolated from the phages (FIG. 2). All the genomes isolated have a size close to 50 Kb, while the restriction pattern of the genomes obtained (RFLP) made it possible to classify them in 3 groups: Group A: F/00074; Group B: F/00072; Group C: F/00073. We were unable to establish the type of nucleic acid for the F/00075 phage and, therefore, also its digestion pattern. A possible explanation is that it may have a genome of RNA, therefore it was considered as a fourth group (Table 2).

TABLE 2
Characterization of isolated phages that infect Vibrio anguillarum.

| | | | | Genome | Sensitivity | |
|---|---|---|---|---|---|---|
| | RFLP | Type of | Nucleic | size | to | Storage |
| Name | Group | sample | Acid | (Kb) | chloroform | temp. |
| F/00072 | B | mussel | DNA | 48.6 | no | −80° C. |
| F/00073 | C | clams | DNA | 47 | no | −80° C. |
| F/00074 | A | mussel | DNA | 48.3 | no | 4° C. |
| F/00075 | N/D | clams | N/D | N/D | yes | 4° C. |

N/D: not determined

In order to determine the host range of the isolated phages different bacterial strains of V. anguillarum, V. ordalii and V. parahaemolyticus were tested to execute the standard method of double agar and determine the lytic effect of the different phages on these bacteria. Table 3 shows that all the phages have the same host range. All the phages are capable of infecting some tested strains of V. anguillarum and V. ordalii, but none is capable of infecting tested strains of V. parahaemolyticus.

TABLE 3
Host range of isolated phages that infect Vibrio anguillarum.

| Phage | VoATCC | VpKX | Vp1183 | Vp57.5 | VaATCC | VaPF4 | VaPF7 | VaPF8 |
|---|---|---|---|---|---|---|---|---|
| F/00072 | +++ | − | − | − | − | +++ | − | +++ |
| F/00073 | ++ | − | − | − | − | ++ | − | + |
| F/00074 | +++ | − | − | − | − | +++ | − | +++ |
| F/00075 | ++ | − | − | − | − | ++ | − | +++ |

(Vo: Vibrio ordalii. Vp: Vibrio parahaemolyticus. Va: Vibrio anguillarum).
The sign “+” indicates the degree of lysis observed, while the sign “−” indicates that no lysis was observed.

Finally, the frequency of resistant bacteria was determined for the isolated phages. Table 4 shows that the phage F/00074 has the lowest frequency of resistant bacteria (1 in 5.63×10⁻⁶), while the phage F/00075 has a greater frequency of resistant bacteria (1 in 1.63×10⁻²). Using the combination of both phages, the frequency of resistant bacteria is similar to that observed only with the phage F/00074.

TABLE 4
Resistance rate of PF4 strain of Vibrio anguillarum with the
isolated phages F/00075 and F/00074 and with their mixture.

| | Rate of resistant |
|---|---|
| Phages | bacteria |
| F/00075 | 1 in 1.63 × 10⁻² |
| F/00074 | 1 in 5.63 × 10⁻⁶ |
| F/00075 + F/00074 | 1 in 5.63 × 10⁻⁶ |

### Example 3

### Challenges

The phages used in the challenges were selected according to their stability over time, type of storage and their lytic capacity.

The phages F/00074 and F/00075 were selected to execute the challenges in fish under laboratory conditions.

A specific number of fish of the Salmo salar species were maintained in tanks with 15 liters of water at 1% of NaCl. Three conditions were used for each challenge:
1) Control: only fresh culture medium is added to the tank.
2) Bacteria: A bacterial culture of the PF4 strain of V. anguillarum is added to a known concentration.
3) Phage+Bacteria: The same bacterium and amount of condition 2 is added and a phage is also added at a specific concentration.

In some cases a fourth condition was added associated with tanks where only the phage was added.

Fish mortality was monitored daily.

The bacterium used originates from a bacterial medium in exponential phase.

To produce the phage, a culture of the bacterium V. anguillarum in an early exponential phase was infected with a multiplicity of infection (MOI) of 10 and incubated with agitation at 25° C. during one night. The culture was centrifuged and filtered (0.22 μM). The titer of the filtrate was obtained using the standard double agar method and then it was used in the challenge tests directly.

The challenges were carried out with a single phage or with a mix of the two phages.

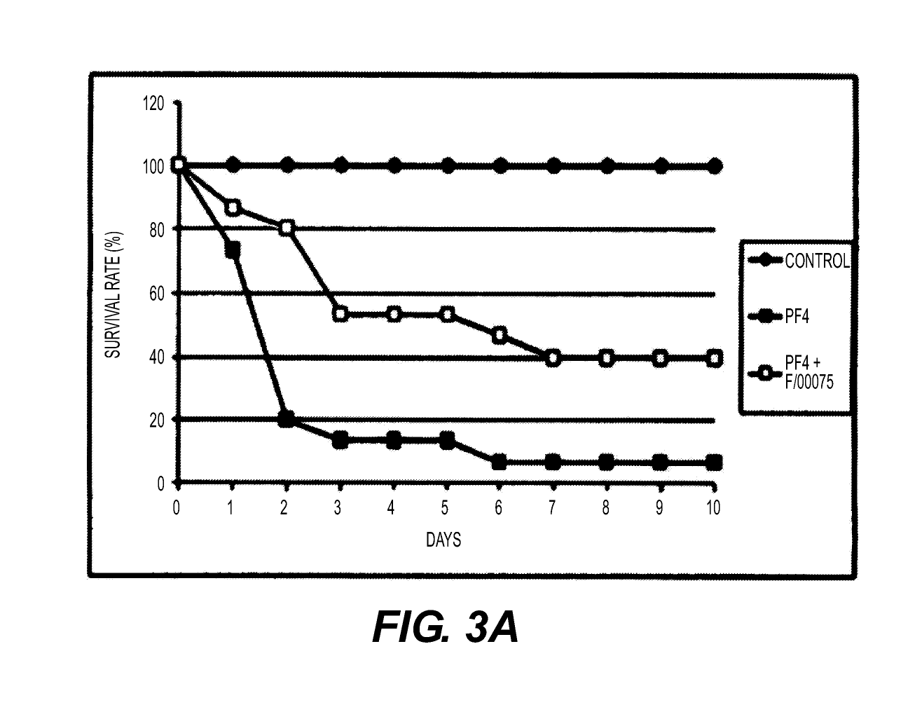

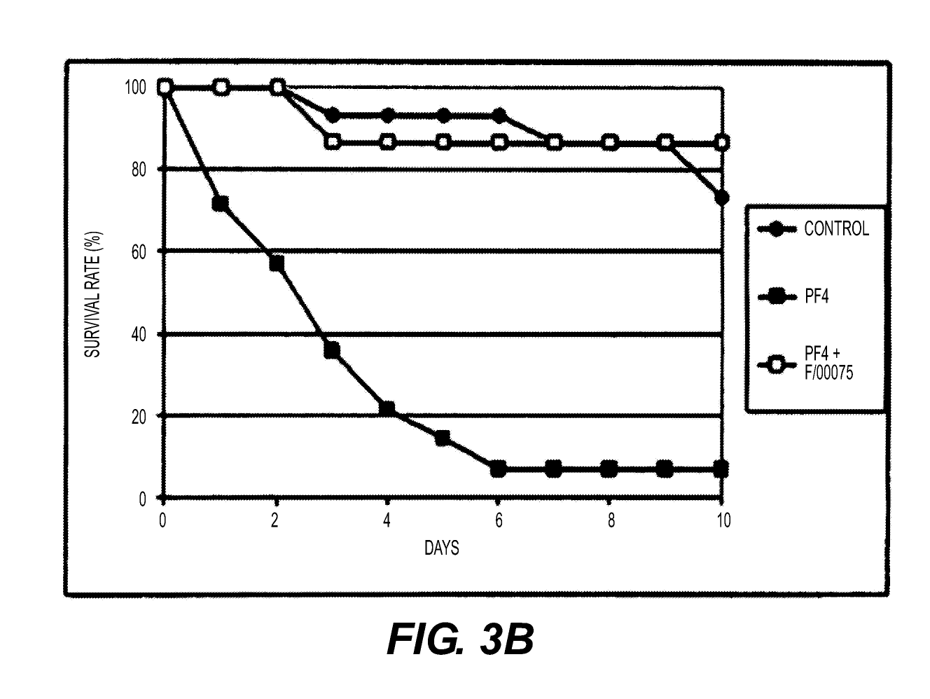

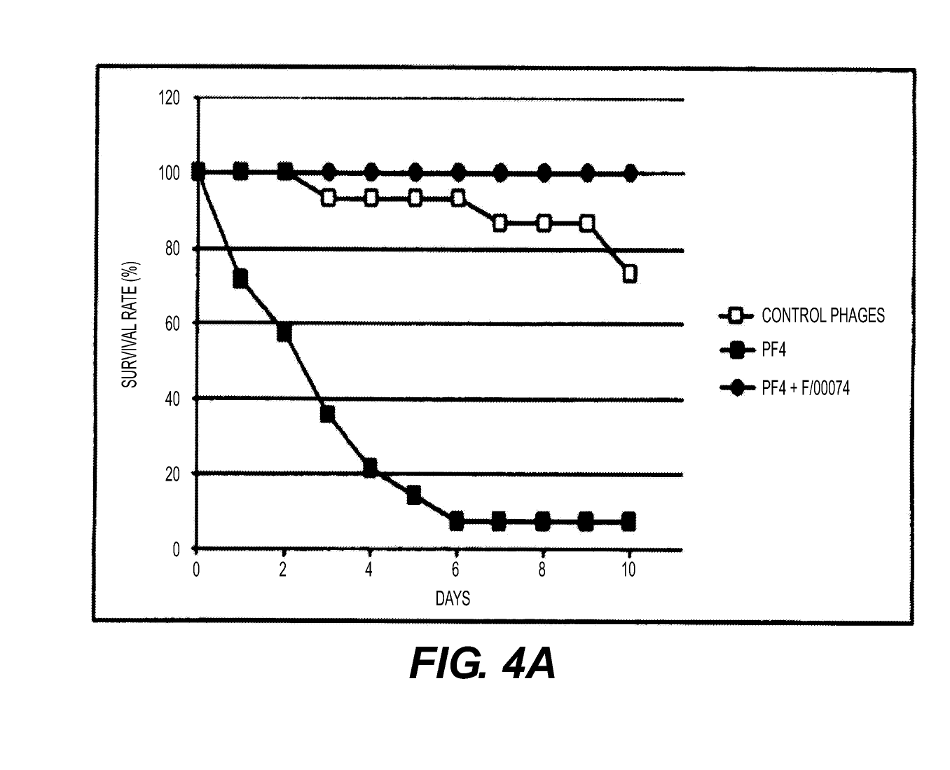

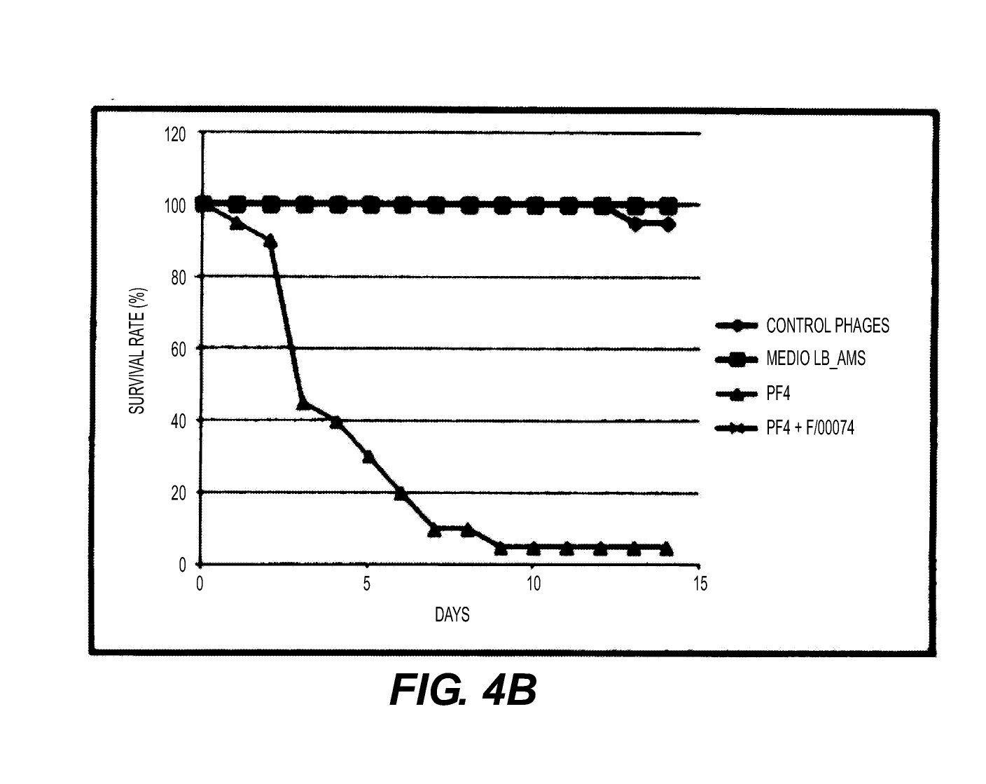

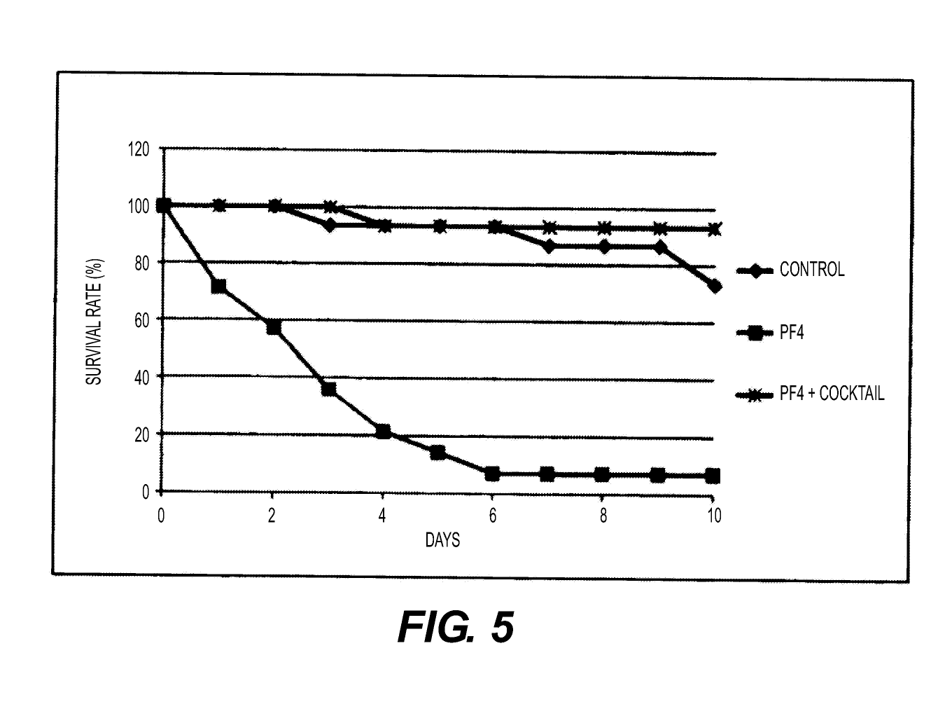

The graphs of the challenges show that both the F/00075 as well as the F/00074 are able to protect against the infection of the V. anguillarum PF4. By using the phage F/00075 close to 40% protection is obtained when a MOI of 7 is used (FIG. 3A), while when an MOI of 150 is used, the protection reaches 100% (FIG. 3B). When the phage F/00074 is used with a MOI of 1, the protection achieved is 100% for all the challenges carried out (FIG. 4). While using a mix of the phages F/00075 and F/00074 a protection of close to 90% is reached (FIG. 5).

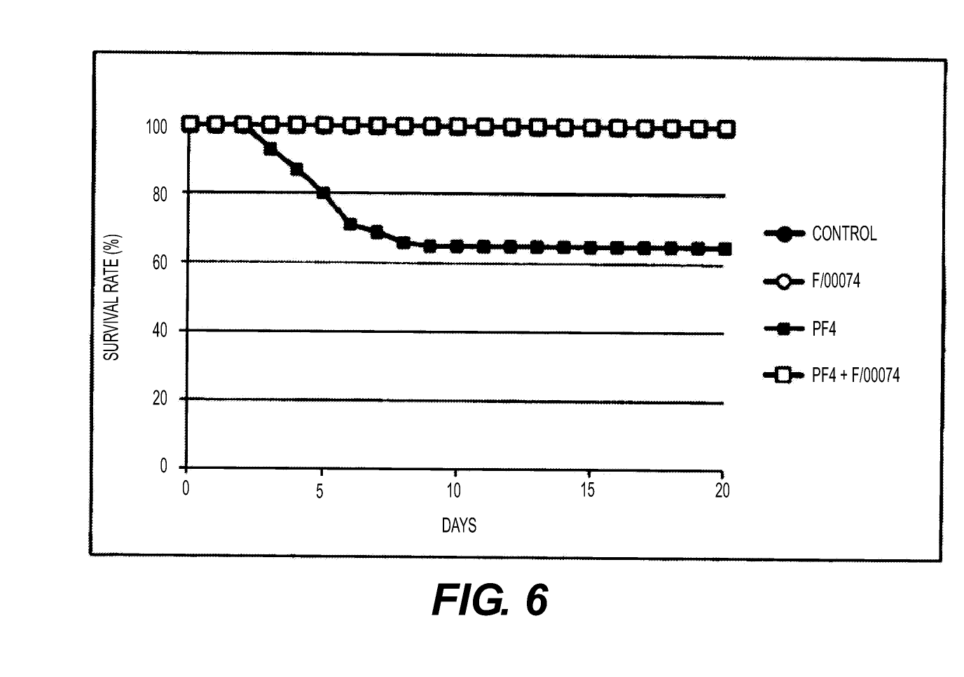

On the other hand, a challenge was carried out at the Chinquihue Center (Puerto Montt), a place that maintains similar conditions for salmonid farming, mainly in tanks with seawater. The conditions of the protection challenge with phage F/00074 were similar to those described for the challenges in the laboratory, with the exception that 100 fish were used for each group. As a result there was 100% protection for the group treated with the phage F/00074 (FIG. 6).

These results prove that the isolated phages have the potential of protecting the fish against the infection generated by the bacterial strain PF4 of V. anguillarum.

### Example 4

### Formulation 1

A liquid or semisolid formulation in a buffer medium at pH between 4 and 10 that includes:

| F/OOO72 | 10¹⁰ | ufp/ml |
|---|---|---|
| F/OO073 | 10¹⁰ | ufp/mI |
| F/OOO74 | 10¹⁰ | ufp/ml |
| F/OOO75 | 10¹⁰ | ufp/ml |
| Tris | 200 | mM |
| NaCI | 9 | g/L |
| MgS04 | 10 | mM |
| Guar gum | 100 | mg/L |
| Bovine serum albumin | 1 | mg/L |

### Example 5

### Formulation 2

Liquid or semisolid formulation in a buffer medium at pH between 4 and 10 that includes:

| F/OOO74 | 10¹⁰ | ufp/ml |
|---|---|---|
| Tris | 200 | mM |
| NaCl | 9 | g/L |
| MgS04 | 10 | mM |
| Guar gum | 100 | mg/L |
| Bovine serum albumin | 1 | mg/L |

### Example 6

### Formulation 3

Liquid or semisolid formulation in a buffer medium at a pH of 4 to 10, that includes:

| F/OOO75 | 10¹⁰ | ufp/ml |
|---|---|---|
| Tris | 200 | mM |
| NaCl | 9 | g/L |
| MgS04 | 10 | mM |
| Guar gum | 100 | mg/L |
| Bovine serum albumin | 1 | mg/L |

### Example 7

### Formulation 4

Liquid or semisolid formulation in a buffer medium at a pH of 4 to 10, that includes:

| F/OOO74 | 10¹⁰ | ulp/ml |
|---|---|---|
| F/OOO75 | 10¹⁰ | ufp/ml |
| Tris | 200 | mM |
| NaCl | 9 | g/L |
| MgS04 | 10 | mM |
| Guar gum | 100 | mg/L |
| Bovine serum albumin | 1 | mg/L |

### REFERENCES

Almeida, A., A. Cunha, et al. (2009). Phage therapy and photodynamic therapy: low environmental impact approaches to inactivate microorganisms In fish farming plants.' Mar Drugs 7(3): 268-313.
Borysowski, J. and A. Gorski (2008). “Is phage therapy acceptable in the Immunocompromised host?” Int J Infect Dis 12(5): 466-471.
Cabello, F. C. (2006). “Heavy use of prophylactic antibiotics In aquaculture: a growing problem for human and animal health and for the environment. Environ Microbiol 8(7): 1137-1144.
Castillo, O; Higuera, G; Villa, M; Middelboe, M; Dalsgaard, L; Madsen, L; Espejo, R T. (2012). “Diversity of Flavobacterium psychorophilum and the potential use of its phages for protection against bacterial cold water disease In salmonids”, Journal of Fish Diseases 35 (3): 193-201.
Crothers-Stomps, C; Hoj, L; Bourne, DG; Hall, MR; Owens, L. (2010). “Isolation of Iytic bacteriophage against Vibrio harveyi” Journal of Applied Microbiology 108 (5): 1744-1750.
Frans, I., C. W. Michiels, et al. (2011). “Vibrio anguillarum as a fish pathogen: virulence factors, diagnosis and prevention” J Fish Dis 34(9): 643-661.
Housby, J. N. and N. H. Mann (2009). “Phage therapy” Drug Discov Today 14(11-12): 538-540.
Karunasagar, I; Shivu, MM; Girisha, SK; Krohne, G (2007). “Biocontrol of pathogens in shrimp hatcheries using bacteriophages”. Aquaculture 268 (1-4): 288-292 Sp. 188.SI.
Kim, J. H., D. K. Gómez, et al. (2010). “Isolation and identification of bacteriophages infecting ayu Plecoglossus altivelis altivelis specific Flavobacterium psychrophilum”. Vet Microbiol 140(1-2): 109-115.
Kutateladze, M. and R. Adamia (2010). “Bacteriophages as potential new therapeutics to replace or supplement antibiotics.” Trends Biotechnol 28(12): 591-595.
Marshall, B. M. and S. B. Levy (2011). “Food animals and antimicrobials: impacts on human health.” Clin Microbiol Rev. 24(4): 718-733.
Millanao, B. A., H. M. Barrientos, et al. (2011). “[Injudicious and excessive use of antibiotics: public health and salmon aquaculture in Chile].” Rev Med Chile 139(1): 107-118.
Pereira, C; Silva, V J; Santos, A L; Cunha, A; Gomes, NCM; Almeida, A. (2011). “Bacteriophages with potential for inactivation of fish pathogenic bacteria: survival, host specificity and effect on bacterial community structure”. Marine Drugs: 9 (11): 2238-2255
Phumkhachorn, P; Rattanachaikunsopon, P. (2010). “Isolation and partial characterization of a bacteriophage infecting the shrimp pathogen Vibrio harveyi”, African Journal of Microbiology Research 4 (16): 1794-1800.
Prasad, Y; Aparna; Kumar, D (2010). “Isolation and efficacy evaluation of virulent bacteriophages specific to fish pathogenic bacterium, Flavobacterium columnare” Journal of Applied Animal Research 38 (2): 169-174.
Shivu, MM; Rajeeva, BC; Girisha, SK; Karunasagar. I; Krohne, G. (2007). “Molecular Characterization of Vibrio harveyi bacteriophages isolated from aquaculture environments along the coast of India”. Environmental Microbiology 9 (2): 322.331.
Silva-Rubio. A., C. Acevedo, et al. (2008). “Antigenic and molecular characterization of Vibrio ordalii strains isolated from Atlantic salmon Salmo salar in Chile.” Dis Aquat Organ 79(1): 27-35.
Silva-Rubio, A., R. Avendano-Herrera, et al. (2008). “First description of serotype 03 in Vibrio anguillarum strains isolated from salmonids in Chile.” J Fish Dis 31(3): 235-239.
Stanholm. A. R., 1. Dalsgaard, et al. (2008). “Isolation and characterization of bacteriophages infecting the fish pathogen Flavobacterium psychrophilum”. Appl Environ Microbiol 74(13): 4070-4078.
Thiyagarajan, S; Chrisolite, B; Alavandi. SV; Poomima, M; Kalaimani, N; Santiago, TC. (2011). “Characterization of four Iytic transducing bacteriophages of luminescent Vibrio harveyi isolated from shrimp (Penaeus monodon) hatcheries”. Fems Microbiology Letters 325 (1): 85-91.
Vinod. MG; Shivu. MM; Umesha, KR; Rajeeva. BC; Krohne. G; Ka-Unasagar, I; Karunasagar, 1. (2006). “isolation of Vibrio harveyi bacteriophage with a potential for biocontrol of luminous vibriosis in hatchery environments”. Aquaculture 255 (1-4): 117-124.
Wommack. K. E. and R. R. Colwell (2000). “Virioplankton: viruses in aquatic ecosystems”. Microbiol Mol Biol Rev 64(1): 69-114.

1. An isolated strain of bacteriophage, specific against bacteria belonging to the Vibrio genre, particularly the anguillarum species, deposited on 3 Oct. 2012 at the Polish Collection of Microorganisms (PCM) of the Ludwik Hirszfeld Institute of Immunology and Experimental Therapy of the Polish Academy of Sciences, with access number F/00072, characterized in that said strain is efficient in the prophylaxis, control and/or treatment of the infection caused by Vibrio anguillarum in all types of species of fish, mollusks and crustaceans that are important for aquaculture susceptible to this bacteria, genome size 48.6 Kb, it is not sensitive to chloroform and its storage temperature is −80° C.

2. An isolated strain of bacteriophage, belonging to the Siphoviridae family, specific against bacteria belonging to the Vibrio genre, particularly the anguillarum species, deposited on 3 Oct. 2012 at the Polish Collection of Microorganisms (PCM) of the Ludwik Hirszfeld Institute of Immunology and Experimental Therapy of the Polish Academy of Sciences, with access number F/00073, characterized in that said strain is efficient in the prophylaxis, control and/or treatment of the infection caused by Vibrio anguillarum in all types of species of fish, mollusks and crustaceans that are important for aquaculture susceptible to this bacteria, its head is shaped like an icosahedrons, it has a long tail, is not retractile, genome size 47 Kb, it is not sensitive to chloroform, and its storage temperature is −80° C.

3. An isolated strain of bacteriophage, belonging to the Siphoviridae family, specific against bacteria belonging to the Vibrio genre, particularly the anguillarum species, deposited on 3 Oct. 2012 at the Polish Collection of Microorganisms (PCM) of the Ludwik Hirszfeld Institute of Immunology and Experimental Therapy of the Polish Academy of Sciences, with access number F/00074, characterized in that said strain is efficient in the prophylaxis, control and/or treatment of the infection caused by Vibrio anguillarum in all types of species of fish, mollusks and crustaceans that are important for aquaculture susceptible to this bacteria, its head is shaped like an icosahedrons, it has a long tail, is not retractile, genome size 48.3 Kb, it is not sensitive to chloroform and its storage temperature is 4° C.

4. An isolated strain of bacteriophage, specific against bacteria belonging to the Vibrio genre, particularly the anguillarum species, deposited on 3 Oct. 2012 at the Polish Collection of Microorganisms (PCM) of the Ludwik Hirszfeld Institute of Immunology and Experimental Therapy of the Polish Academy of Sciences, with access number F/00075, characterized in that said strain is efficient in the prophylaxis, control and/or treatment of the infection caused by Vibrio anguillarum in all types of species of fish, mollusks and crustaceans that are important for aquaculture susceptible to this bacteria, its head is shaped like an icosahedrons, it has a long tail, is not retractile, it is sensitive to chloroform and its storage temperature is 4° C.

5. An antibacterial composition to be applied as prophylaxis, control and/or treatment of the infection caused by V. anguillarum in all types of crops of fishes, mollusks and crustaceans susceptible to this pathogen bacteria, characterized in that it includes at least one bacteriophage strain selected among the strains deposited on 3 Oct. 2012 at the Polish Collection of Microorganisms (PCM) of the Ludwik Hirszfeld Institute of Immunology and Experimental Therapy of the Polish Academy of Sciences with the access number F/00072, F/00073, F/00074 and F/00075, or any combination of them.

6. An antibacterial composition according to claim 5, characterized in that it also comprises a buffer solution and/or nutrients and/or phage stabilizers and/or thickeners and/or other excipients.

7. An antibacterial composition according to claim 5, characterized in that it includes at least one phage strain selected among the strains deposited on 3 Oct. 2012 at the Polish Collection of Microorganisms (PCM) of the Ludwik Hirszfeld Institute of Immunology and Experimental Therapy of the Polish Academy of Sciences with the access number F/00072, F/00073, F/00074 and F/00075, or any combination of them, in a multiplicity of infection (MOI) of between 1 and 200.

8. An antibacterial composition according to claim 7, characterized in that it includes at least one phage strain selected among the strains deposited on 3 Oct. 2012 at the Polish Collection of Microorganisms (PCM) of the Ludwik Hirszfeld Institute of Immunology and Experimental Therapy of the Polish Academy of Sciences with the access number F/00072, F/00073, F/00074 and F/00075, or any combination of them, in a multiplicity of infection (MOI) of 200.

9. An antibacterial composition according to claim 5, characterized in that it is applied to crops of any species of fish, mollusks or crustaceans susceptible to being infected by V. anguillarum, for prophylaxis, control and/or treatment of this infection.

10. An antibacterial composition according to claim 9, characterized in that it is applied to crops of all types of salmonids, cod, sea bream, bass, turbot, eel and ayu for prophylaxis, control and/or treatment of the infection caused by V. anguillarum.

11. An antibacterial composition according to claim 9, characterized in that it is applied to crops of oysters, clams, mussels or any filtering bivalve for prophylaxis, control and/or treatment of the infection caused by V. anguillarum.

12. An antibacterial composition according to claim 9, characterized in that it is applied to crops of saltwater shrimp, for prophylaxis, control and/or treatment of the infection caused by V. anguillarum.

13. An antibacterial composition according to claim 9, characterized in that it is added directly to the water in which the species to be treated are being cultivated, or else it is used to associate it to controlled liberation matrixes or to be included in the food.

14. The formula of the antibacterial composition according to claim 5, characterized in that it is a concentrated form that comprises at least one phage strain selected from among the strains deposited on 3 Oct. 2012 at the Polish Collection of Microorganisms (PCM) of the Ludwik Hirszfeld Institute of Immunology and Experimental Therapy of the Polish Academy of Sciences with the access number F/00072, F/00073, F/00074 and F/00075, or any combination of them.

15. The formula according to claim 14, characterized in that it comprises any combination of the phage strains selected from among the strains deposited on 3 Oct. 2012 at the Polish Collection of Microorganisms (PCM) of the Ludwik Hirszfeld Institute of Immunology and Experimental Therapy of the Polish Academy of Sciences with the access number F/00072, F/00073, F/00074 and F/00075, in different proportions.

16. The formula according to claim 14, characterized in that it comprises any combination of the phage strains selected from among the strains deposited on 3 Oct. 2012 at the Polish Collection of Microorganisms (PCM) of the Ludwik Hirszfeld Institute of Immunology and Experimental Therapy of the Polish Academy of Sciences with the access number F/00072, F/00073, F/00074 and F/00075, in equal proportions.

17. The formula according to claim 14, characterized in that it also includes excipients.

18. The formula according to claim 14, characterized because it is a liquid or semisolid formulation, prepared in a buffered medium with pH 4 to 10, that comprises F/00072: between O ufp/ml and 1×10¹⁰ ufp/ml; F/OOO73: between O and 1×10¹⁰ ufp/ml; F/OOO74: between O ufp/ml and 1×10¹⁰ ufp/ml; F/OOO75: between O ufp/ml and 1×10¹⁰ ufp/ml.

19. The formula according to claim 18, characterized in that it also comprises nutrients and/or stabilizers of phages and/or thickeners and/or other excipients.

20. The formula according to claim 19, characterized in that it also comprises one or more of the following components: Tris as a buffer solution that has a pH ranging between 4 and 10; NaCl; MgSO₄; guar gum and/or bovine serum albumin.

21. The formula according to claim 20, characterized in that it is a liquid or semisolid formulation in a buffered medium at pH 4 to 10, that comprises F/00072: 10¹⁰ ufp/ml; F/00073: 10¹⁰ ufp/ml; F/00074: 10¹⁰ ufp/ml; F/00075: 10¹⁰ ufp/ml; Tris: 200 mM; NaCl: 9 g/L; MgSO₄: 10 mM; guar gum: 100 mg/L; and bovine serum albumin: 1 mg/L.

22. The formula according to claim 20, characterized in that it is a liquid or semisolid formulation in a buffered medium at pH 4 to 10 that comprises F/00074: 10¹⁰ ufp/ml; Tris: 200 mM; NaCl: 9 g/l; MgSO₄: 10 mM; guar gum: 100 mg/L; and bovine serum albumin: 1 mg/L.

23. The formula according to claim 20, characterized in that it is a liquid or semisolid formulation in a buffered medium at pH 4 to 10 that comprises F/00075: 10¹⁰ ufp/ml; Tris: 200 mM; NaCl: 9 g/l; MgSO₄: 10 mM; guar gum: 100 mg/L; and bovine serum albumin: 1 mg/L.

24. The formula according to claim 20, characterized in that it is a liquid or semisolid formulation in a buffered medium at pH 4 to 10 that comprises F/00074: 10¹⁰ ufp/ml; F/00075: 10¹⁰ ufp/ml; Tris: 200 mM; NaCl: 9 g/l; MgSO₄: 10 mM; guar gum: 100 mg/L; and bovine serum albumin: 1 mg/L.

25. The formula according to claim 14, characterized in that is it applied to crops of any species of fish, mollusks or crustaceans susceptible of being infected by V. anguillarum, for prophylaxis, control and/or treatment of this infection.

26. The formula according to claim 25, characterized in that it is applied to crops of all types of salmonids, cod, sea bream, bass, turbot, eel and ayu, for prophylaxis, control and/or treatment of the infection caused by V. anguillarum.

27. The formula according to claim 25, characterized in that it is applied to crops of oysters, clams, mussels or any filtrating bivalve, for prophylaxis, control and/or treatment of the infection caused by V. anguillarum.

28. The formula according to claim 25, characterized in that it is applied to crops of saltwater shrimp for prophylaxis, control and/or treatment of the infection caused by V. anguillarum.

29. The formula according to claim 25, characterized in that it is applied directly to the water in which the species to be treated are being cultivated, or else it is used to associate it to controlled liberation matrixes or to include it in the food.
